(19) United States
(12) Patent Application Publication
(10) Pub. No.: US 2025/0026229 A1
(43) Pub. Date: Jan. 23, 2025

(54) CONTROL DEVICE

(71) Applicant: SUBARU CORPORATION, Tokyo (JP)

(72) Inventor: Shinya HORIE, Tokyo (JP)

(21) Appl. No.: 18/906,494

(22) Filed: Oct. 4, 2024

Related U.S. Application Data
(63) Continuation of application No. PCT/JP2023/025036, filed on Jul. 5, 2023.

(51) Int. Cl. B60L 53/65; B60L 53/66; H01M 10/44

(52) U.S. Cl. CPC B60L 53/65; B60L 53/66; H01M 10/441; H01M 2220/20

(57) ABSTRACT

A control device includes one or more processors and one or more memories coupled to the one or more processors. The one or more processors are configured to execute processing. The processing includes: acquiring identification information for identifying a vehicle that is to enter a charging station; associating the identification information with a charger among chargers located in the charging station; and permitting a battery of the vehicle identified by the identification information to be charged using the charger with which the identification information is associated.

### CROSS-REFERENCE TO RELATED APPLICATIONS

This application is continuation of International Application No. PCT/JP2023/025036, filed on Jul. 5, 2023, the entire contents of which are hereby incorporated by reference.

### BACKGROUND

The disclosure relates to a control device.

In the related art, there are known electric vehicles that can be driven by motors using electric power stored in batteries. Charging stations having chargers capable of supplying electric power to batteries of electric vehicles are installed in various locations to charge the batteries. Such a charging station is disclosed in Japanese Unexamined Patent Application Publication No. 2011-114969. The charging station is provided with a control device that communicates with a control device disposed in a vehicle to exchange information, and the exchanged information is used to predict the time of completion of charging of the vehicle.

### SUMMARY

An aspect of the disclosure provides a control device including one or more processors and one or more memories coupled to the one or more processors. The one or more processors are configured to execute processing. The processing includes: acquiring identification information for identifying a vehicle that is to enter a charging station; associating the identification information with a charger among chargers located in the charging station; and permitting a battery of the vehicle identified by the identification information to be charged using the charger with which the identification information is associated.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic configuration diagram of a control system according to an embodiment of the disclosure;

FIG. 2 is a schematic configuration block diagram of a first control device and a second control device according to the embodiment of the disclosure;

FIG. 3 is a block diagram illustrating an example functional configuration of the first control device according to the embodiment of the disclosure;

FIG. 4 is a block diagram illustrating an example functional configuration of the second control device according to the embodiment of the disclosure;

FIG. 5 is a schematic diagram illustrating an example of an association process performed by a determiner;

FIG. 6 is a schematic diagram illustrating another example of the association process performed by the determiner; and

FIG. 7 is a flowchart of a control process performed in the control system according to the embodiment of the disclosure.

### DETAILED DESCRIPTION

A vehicle in a charging station is free to use an available charger that is not in use in the charging station. Accordingly, when a vehicle is to use the available charger, another vehicle may enter between the vehicle and the available charger to cut in front of the vehicle and may be charged before the vehicle, resulting in the vehicle unexpectedly waiting for the charger.

It is therefore desirable to provide a control device capable of preventing unexpected waiting for charging.

An embodiment of the disclosure will be described hereinafter with reference to the accompanying drawings. Specific dimensions, materials, numerical values, and so on provided in the embodiment of the disclosure are merely examples for facilitating understanding of the disclosure, and do not limit the disclosure unless otherwise specified. In the specification and the drawings, elements having substantially the same functions and configurations are denoted by the same reference numerals to omit redundant description, and elements not directly related to the disclosure are not illustrated.

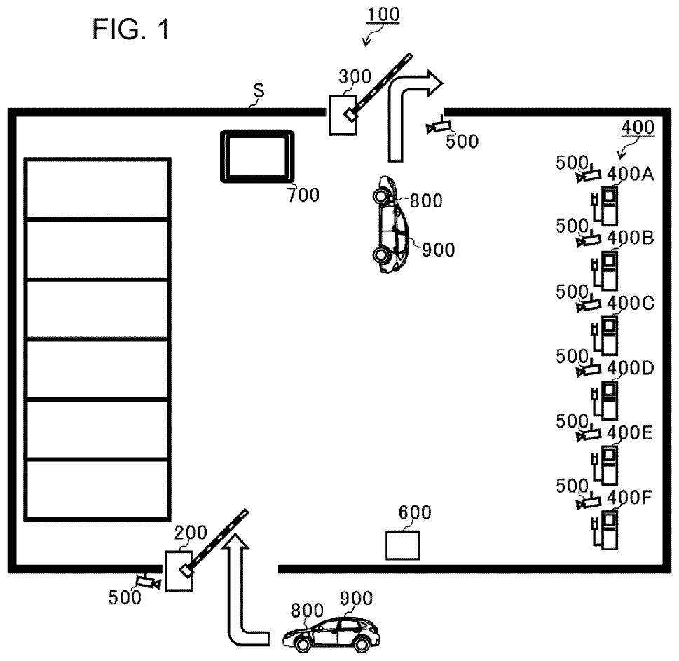

FIG. 1 is a schematic configuration diagram of a control system 100 according to the embodiment of the disclosure. As illustrated in FIG. 1, the control system 100 includes an entrance gate 200, an exit gate 300, chargers 400, imaging devices 500, a first control device 600, a display device 700, and a second control device 800.

The entrance gate 200, the exit gate 300, the chargers 400, the imaging devices 500, the first control device 600, and the display device 700 are disposed in a charging station S. The second control device 800 is disposed in a vehicle 900 that can enter and leave the charging station S.

The entrance gate 200 is disposed at an entrance of the charging station S to open and close the entrance of the charging station S. The exit gate 300 is disposed at an exit of the charging station S to open and close the exit of the charging station S. When the entrance gate 200 is in open position, the vehicle 900 is allowed to pass through the entrance of the charging station S and is allowed to enter the charging station S from the outside. When the entrance gate 200 is in closed position, the vehicle 900 is not allowed to pass through the entrance of the charging station S and is not allowed to enter the charging station S from the outside.

When the exit gate 300 is in open position, the vehicle 900 is allowed to pass through the exit of the charging station S and is allowed to leave the charging station S from the inside. When the exit gate 300 is in closed position, the vehicle 900 is not allowed to pass through the exit of the charging station S and is not allowed to leave the charging station S from the inside.

Each of the chargers 400 includes a cable and a connector. The cable of each of the chargers 400 couples a power source (not illustrated) to the connector. The cable has, for example, a retractable portion having a winding structure, and is configured to be retractable from the charger 400 to a charging port of the vehicle 900. The connector of each of the chargers 400 can be electrically coupled to the charging port of the vehicle 900. The connector can supply alternating current or direct current from the power source (not illustrated) to the charging port of the vehicle 900.

Each of the chargers 400 can supply a larger amount of current when supplying direct current than when supplying alternating current. A charger 400 supplying alternating current can perform normal charging of a battery of the vehicle 900. A charger 400 supplying direct current can perform rapid charging of the battery of the vehicle 900.

The chargers 400 according to the embodiment of the disclosure include a first charger 400A, a second charger 400B, a third charger 400C, a fourth charger 400D, a fifth charger 400E, and a sixth charger 400F. The first charger 400A and the second charger 400B support first type information of batteries mounted on vehicles 900 and first version information. The version information indicates version information of software used in the vehicles 900 for charging. The version information of the software is hereinafter also simply referred to as version information.

The third charger 400C and the fourth charger 400D support second type information of batteries mounted on vehicles 900 and second version information. The fifth charger 400E and the sixth charger 400F support third type information of batteries mounted on vehicles 900 and third version information.

The first type information and the first version information are older than the second type information and the second version information, respectively. The second type information and the second version information are older than the third type information and the third version information, respectively.

Of the chargers 400 of multiple types, the first charger 400A and the second charger 400B support the oldest battery type information and the oldest software version information. The fifth charger 400E and the sixth charger 400F support the latest battery type information and the latest software version information.

If the battery of the vehicle 900 is to be charged using a charger 400 not supporting the battery type information and software version information of the vehicle 900, the charging efficiency may be reduced or the charging of the battery may fail. It is therefore desirable to charge the battery of the vehicle 900 using a charger 400 supporting the battery type information and software version information of the vehicle 900.

Each of the imaging devices 500 captures an image of the vehicle 900. In the embodiment of the disclosure, the imaging devices 500 capture images of a front surface of the vehicle 900 including a license plate of the vehicle 900. However, the disclosure is not limited thereto, and the imaging devices 500 may capture images of a rear surface of the vehicle 900 including the license plate of the vehicle 900. Alternatively, the imaging devices 500 may capture images of the external appearance of the vehicle 900 other than the front surface and the rear surface of the vehicle 900.

The imaging devices 500 are disposed at the entrance gate 200, the exit gate 300, the first charger 400A, the second charger 400B, the third charger 400C, the fourth charger 400D, the fifth charger 400E, and the sixth charger 400F. When the vehicle 900 approaches the entrance gate 200, the exit gate 300, the first charger 400A, the second charger 400B, the third charger 400C, the fourth charger 400D, the fifth charger 400E, or the sixth charger 400F, a corresponding one of the imaging devices 500 captures an image of the vehicle 900. Image data of the images captured by the imaging devices 500 is transmitted to the first control device 600.

The display device 700 displays data transmitted from the first control device 600. The data transmitted from the first control device 600 includes the image data of the images captured by the imaging devices 500, information related to the chargers 400, and so on.

In the description given herein, the vehicle 900 is an electric vehicle with a motor (not illustrated) and a battery (not illustrated) mounted thereon. It is noted that the vehicle 900 is any vehicle including at least a motor (not illustrated) to cause the vehicle 900 to travel and a battery to drive the motor. For example, the vehicle 900 may be a hybrid vehicle including an engine and a motor.

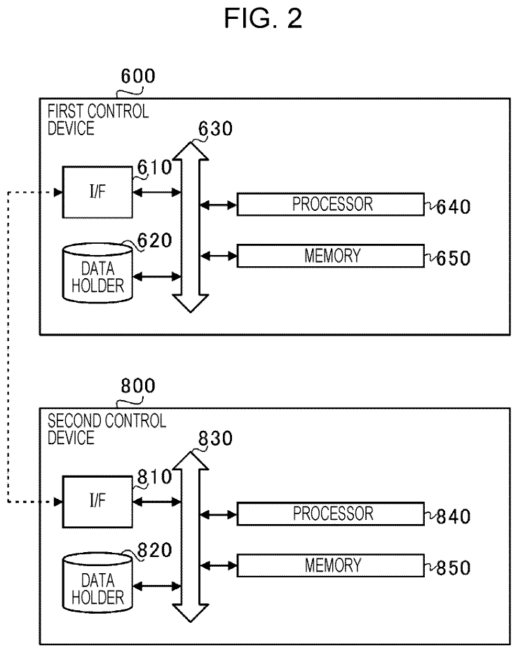

FIG. 2 is a schematic configuration block diagram of the first control device 600 and the second control device 800 according to the embodiment of the disclosure. As illustrated in FIG. 2, the first control device 600 includes an interface (I/F) 610, a data holder 620, a system bus 630, one or more processors 640, and one or more memories 650. The I/F 610 is an interface for communicating with the second control device 800.

The data holder 620 includes, for example, a random access memory (RAM), a flash memory, and a hard disk drive (HDD) and holds various kinds of information to be used for processing of the one or more processors 640 described below. For example, the data holder 620 holds various kinds of data of the vehicle 900, which are acquired via the second control device 800. In one example, the data holder 620 holds, for example, vehicle-related information acquired from the vehicle 900, which will be described in detail below, information related to the chargers 400, and the image data of the images captured by the imaging devices 500. The information related to the chargers 400 includes, for example, battery type information supported by the chargers 400 and software version information supported by the chargers 400. The system bus 630 is a transmission line that electrically couples the I/F 610, the data holder 620, the one or more processors 640, and the one or more memories 650 to one another to transmit data among them.

The one or more processors 640 include, for example, a central processing unit (CPU). The one or more memories 650 include, for example, a read only memory (ROM) and a RAM. The ROM is a storage element that stores programs, operation parameters, and the like used by the CPU. The RAM is a storage element that temporarily stores data of variables, parameters, and the like used for processing executed by the CPU.

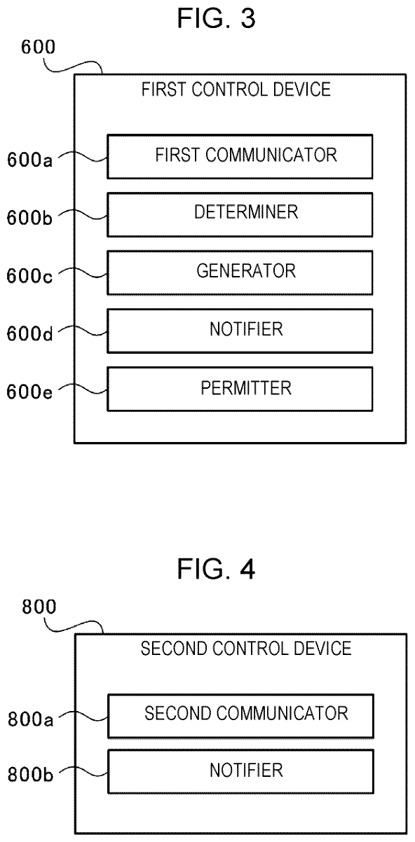

FIG. 3 is a block diagram illustrating an example functional configuration of the first control device 600 according to the embodiment of the disclosure. For example, as illustrated in FIG. 3, the first control device 600 includes a first communicator 600a, a determiner 600b, a generator 600c, a notifier 600d, and a permitter 600e.

Various processes including processes performed by the first communicator 600a, the determiner 600b, the generator 600c, the notifier 600d, and the permitter 600e, which will be described below, may be executed by the one or more processors 640 in cooperation with a program included in the one or more memories 650. In one example, the one or more processors 640 execute a program stored in the one or more memories 650 to perform the various processes.

The first communicator 600a communicates with the second control device 800 mounted on the vehicle 900. The determiner 600b determines, based on the identification information of the vehicle 900, a charger 400 to be associated with the identification information. The generator 600c generates a password to be input to use the charger 400. The notifier 600d notifies the second control device 800 of information such as the password and information on the charger 400 associated with the identification information of the vehicle 900. The permitter 600e permits the battery to be charged using the charger 400 associated with the identification information of the vehicle 900. The first communicator 600a, the determiner 600b, the generator 600c, the notifier 600d, and the permitter 600e will be described in detail below.

Referring back to FIG. 2, the second control device 800 includes an I/F 810, a data holder 820, a system bus 830, one or more processors 840, and one or more memories 850. The I/F 810 is an interface for communicating with the first control device 600.

The data holder 820 includes, for example, a RAM, a flash memory, and an HDD and holds various kinds of information to be used for processing of the one or more processors 840 described below. For example, the data holder 820 holds various kinds of data of the vehicle 900 as vehicle-related information. In one example, the data holder 820 holds, for example, the identification information of the vehicle 900, which will be described in detail below, and information acquired from the first control device 600. The system bus 830 is a transmission line that electrically couples the I/F 810, the data holder 820, the one or more processors 840, and the one or more memories 850 to one another to transmit data among them.

The one or more processors 840 include, for example, a CPU. The one or more memories 850 include, for example, a ROM and a RAM. The ROM is a storage element that stores programs, operation parameters, and the like used by the CPU. The RAM is a storage element that temporarily stores data of variables, parameters, and the like used for processing executed by the CPU.

FIG. 4 is a block diagram illustrating an example functional configuration of the second control device 800 according to the embodiment of the disclosure. For example, as illustrated in FIG. 4, the second control device 800 includes a second communicator 800a and a notifier 800b.

Various processes including processes performed by the second communicator 800a and the notifier 800b, which will be described below, may be executed by the one or more processors 840 in cooperation with a program included in the one or more memories 850. In one example, the one or more processors 840 execute a program stored in the one or more memories 850 to perform the various processes.

The second communicator 800a communicates with the first communicator 600a of the first control device 600. The notifier 800b notifies a driver who is on board the vehicle 900 to drive the vehicle 900 of various kinds of information acquired from the first control device 600.

The operation of the control system 100 will be described in detail hereinafter with reference to FIG. 1. When the vehicle 900 arrives at the entrance gate 200 of the charging station S, communication is performed between the first control device 600 of the charging station S and the second control device 800 of the vehicle 900.

At this time, the first control device 600 acquires vehicle-related information from the second control device 800. The vehicle-related information includes identification information for identifying the vehicle 900 that is to enter the charging station S. Examples of the identification information include vehicle identification number (VIN) information. The VIN information includes a serial number used to individually identify the vehicle 900. The identification information is not limited to the VIN information, and may be vehicle number information.

Alternatively, the vehicle-related information may include information related to the battery of the vehicle 900 and information related to the software used in the vehicle 900 for charging, in addition to the identification information such as the VIN information or the vehicle number information. Examples of the information related to the battery include type information of the battery and state of charge (SOC) information indicating the level of charge of the battery. Examples of the information related to the software used in the vehicle 900 for charging include version information of the software used to charge the battery.

The vehicle-related information acquired by the first control device 600 is stored in advance in the data holder 820 of the second control device 800, and is transmitted from the second communicator 800a of the second control device 800 to the first communicator 600a of the first control device 600.

When the first communicator 600a acquires the vehicle-related information, the determiner 600b of the first control device 600 performs a process of associating the identification information of the vehicle 900, which is included in the acquired vehicle-related information, with any one of the chargers 400 in the charging station S. If the first communicator 600a fails to acquire the identification information of the vehicle 900, the first control device 600 acquires image data of an image captured by the imaging device 500 disposed at the entrance gate 200 and analyzes the vehicle number information of the vehicle 900 by using the image data. Then, the first control device 600 uses the analyzed vehicle number information as the identification information of the vehicle 900 and performs a process of associating the identification information of the vehicle 900 with any one of the chargers 400.

The process of associating the identification information of the vehicle 900 with any one of the chargers 400 will be described in detail hereinafter. The embodiment of the disclosure describes an example in which the vehicle-related information includes the VIN information of the vehicle 900, the information related to the battery, and the information related to the software.

The determiner 600b refers to the type information of the battery of the vehicle 900 and the version information of the vehicle 900 and the information related to the chargers 400 stored in the data holder 620 and determines the charger 400 supporting the type information of the battery of the vehicle 900 and the version information of the vehicle 900.

For example, when the type information is the first type information and the version information is the first version information, the determiner 600b determines that the type information of the battery of the vehicle 900 and the version information of the vehicle 900 are supported by the first charger 400A and the second charger 400B.

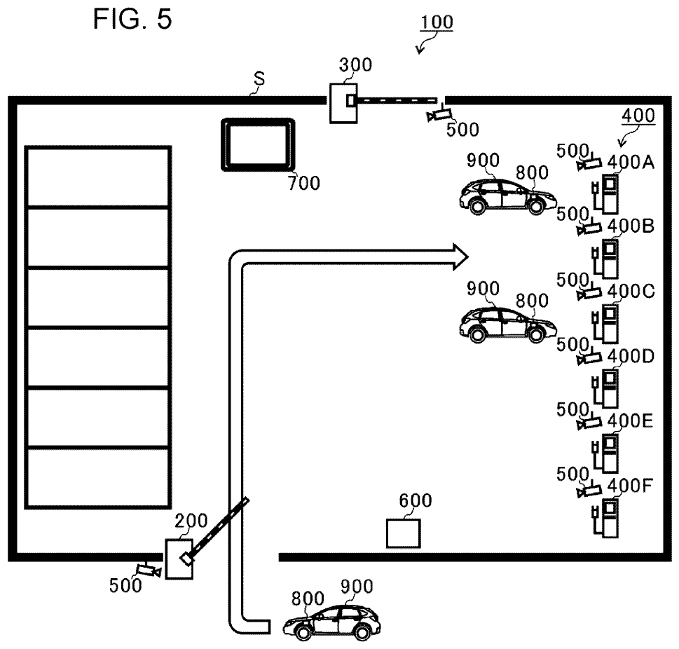

FIG. 5 is a schematic diagram illustrating an example of an association process performed by the determiner 600b. In the example illustrated in FIG. 5, identification information of two vehicles 900 is associated with the first charger 400A and the third charger 400C in advance. As illustrated in FIG. 5, in the charging station S, one of the vehicles 900 comes to a stop in front of the first charger 400A, and the other vehicle 900 comes to a stop in front of the third charger 400C. The first charger 400A and the third charger 400C are occupied by the two vehicles 900.

At this time, another vehicle 900 arrives at the entrance gate 200 of the charging station S. In this case, the first control device 600 acquires vehicle-related information of the vehicle 900 that has arrived at the entrance gate 200, and determines any one of the chargers 400 that supports the type information of the battery of the vehicle 900 and the version information of the vehicle 900. For example, the determiner 600b determines that the type information of the battery of the vehicle 900 and the version information of the vehicle 900 are supported by the first charger 400A and the second charger 400B. The embodiment of the disclosure describes an example in which the determiner 600b determines a charger 400 associated with the identification information of the vehicle 900, based on both the type information of the battery of the vehicle 900 and the version information of the vehicle 900. However, the disclosure is not limited thereto, and the determiner 600b may determine the charger 400 associated with the identification information of the vehicle 900, based on any one of the type information of the battery of the vehicle 900 and the version information of the vehicle 900. For example, the determiner 600b may determine the charger 400 associated with the identification information of the vehicle 900, based on only the type information of the battery of the vehicle 900. Alternatively, the determiner 600b may determine the charger 400 associated with the identification information of the vehicle 900, based on only the version information of the vehicle 900. The same applies to the following description.

At this time, the determiner 600b refers to the data holder 620 and determines whether there is any identification information already associated with the first charger 400A and whether there is any identification information already associated with the second charger 400B. In the illustrated example, it is determined that there is any identification information already associated with the first charger 400A. The determiner 600b determines that the first charger 400A is currently in use or the first charger 400A is expected to be used in the near future. In contrast, it is determined that there is no identification information associated with the second charger 400B. The determiner 600b determines that the second charger 400B is not currently in use.

At this time, of the first charger 400A and the second charger 400B, the first charger 400A is in use. Accordingly, the determiner 600b performs an association process to associate the second charger 400B, which is not in use, with the identification information of the vehicle 900. The identification information of the vehicle 900 and the information on the charger 400, which are associated with each other by the association process, are stored in the data holder 620 of the first control device 600.

As a result, the determiner 600b determines the charger 400 supporting the type information of the battery of the vehicle 900 and the version information of the vehicle 900 among the chargers 400 other than the charger 400 currently in use. Then, the determiner 600b performs an association process to associate the determined charger 400 with the identification information of the vehicle 900.

When the determiner 600b performs the process of associating the charger 400 with the identification information of the vehicle 900, the generator 600c generates a password corresponding to the identification information. The generated password is also stored in the data holder 620 of the first control device 600 in association with the identification information of the vehicle 900 and information on the charger 400.

The notifier 600d transmits the generated password to the second communicator 800a of the second control device 800 via the first communicator 600a of the first control device 600. The notifier 800b of the second control device 800 notifies the driver of the vehicle 900 of the password received from the second communicator 800a. For example, the notifier 800b is a display device of a car navigation system mounted on the vehicle 900. The display device displays the password to notify the driver of the vehicle 900 of the password. The notifier 800b may be a speaker mounted on the vehicle 900. In this case, the speaker generates voice to notify the driver of the vehicle 900 of the password. As a result, the driver of the vehicle 900 is notified of the generated password.

The embodiment of the disclosure describes an example in which the generator 600c generates a password. However, the generation of a password is not required. Accordingly, the process of associating the identification information of the vehicle 900 with any one of the chargers 400 may be performed by the determiner 600b without generation of a password.

When the process of associating the identification information of the vehicle 900 with any one of the chargers 400 is performed, the entrance gate 200 is controlled to change from the closed position to the open position to allow the vehicle 900 to enter the charging station S. At this time, the notifier 600d transmits the information on the charger 400 associated with the identification information of the vehicle 900 to the second communicator 800a of the second control device 800 via the first communicator 600a of the first control device 600. Accordingly, the driver of the vehicle 900 is notified of the information on the charger 400 associated with the identification information. In the illustrated example, the driver of the vehicle 900 is notified of the information on the second charger 400B associated with the identification information.

In response to being notified of the information on the second charger 400B, as illustrated in FIG. 5, the driver of the vehicle 900 can drive the vehicle 900 from the entrance gate 200 to the second charger 400B. When the vehicle 900 arrives in front of the second charger 400B, the first control device 600 communicates with the second control device 800 of the vehicle 900 located in front of the second charger 400B, and re-acquires the vehicle-related information including the identification information of the vehicle 900 from the second control device 800.

The permitter 600e refers to the data holder 620 and checks whether the charger 400 associated with the re-acquired identification information matches the second charger 400B. In other words, the permitter 600e checks whether the identification information of the vehicle 900 located in front of one of the chargers 400 matches identification information associated with the charger 400.

Further, the driver of the vehicle 900 inputs the notified password to an input unit (not illustrated) of the second charger 400B. The permitter 600e refers to the data holder 620 and checks whether the input password matches a password associated with the re-acquired identification information.

When a match is found, the permitter 600e permits the charger 400 associated with the identification information of the vehicle 900 to be used to charge the battery of the vehicle 900 corresponding to the identification information. This allows the vehicle 900 entering the charging station S to use only the charger 400 associated with the identification information of the vehicle 900. Accordingly, even if another vehicle cuts in front of the vehicle 900 and comes to a stop in front of the second charger 400B, the other vehicle is not allowed to use the second charger 400B since the identification information of the other vehicle is not associated with the second charger 400B. Thus, the other vehicle can be prevented from cutting in line to charge first. As a result, it is possible to prevent unexpected waiting for charging in the charging station S.

Further, the determiner 600b determines the charger 400 associated with the identification information of the vehicle 900, based on the information related to the battery of the vehicle 900. For example, the determiner 600b determines the charger 400 associated with the identification information of the vehicle 900, based on the type information of the battery of the vehicle 900. This allows the vehicle 900 to be charged using the charger 400 supporting the type information of the battery mounted on the vehicle 900. Accordingly, the battery can be charged efficiently.

Additionally or alternatively, the determiner 600b determines the charger 400 associated with the identification information of the vehicle 900, based on the information related to the software used in the vehicle 900 for charging. This allows the vehicle 900 to be charged using the charger 400 supporting the version information of the software used for charging. Accordingly, the battery can be charged efficiently.

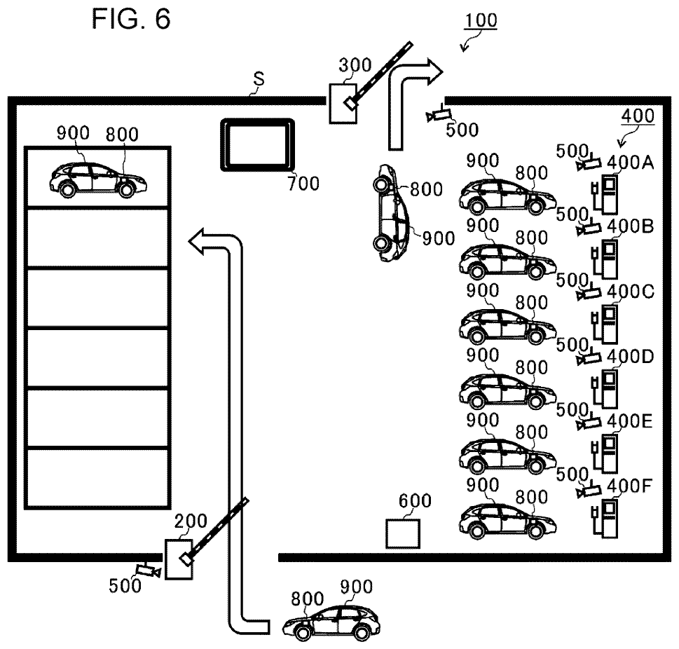

FIG. 6 is a schematic diagram illustrating another example of the association process performed by the determiner 600b. In the example illustrated in FIG. 6, each of pieces of identification information of six vehicles 900 is associated with one of the first charger 400A, the second charger 400B, the third charger 400C, the fourth charger 400D, the fifth charger 400E, and the sixth charger 400F in advance. In the charging station S, the vehicles 900 come to a stop in front of the first charger 400A, the second charger 400B, the third charger 400C, the fourth charger 400D, the fifth charger 400E, and the sixth charger 400F. All the chargers 400 in the charging station S are occupied by the six vehicles 900.

At this time, another vehicle 900 arrives at the entrance gate 200 of the charging station S. In this case, the first control device 600 acquires vehicle-related information of the vehicle 900 that has arrived at the entrance gate 200, and determines any one of the chargers 400 that supports the type information of the battery of the vehicle 900 and the version information of the vehicle 900.

For example, the determiner 600b determines that the type information of the battery of the vehicle 900 and the version information of the vehicle 900 are supported by the fifth charger 400E and the sixth charger 400F. At this time, the determiner 600b refers to the data holder 620 and determines whether there is any identification information already associated with the fifth charger 400E and whether there is any identification information already associated with the sixth charger 400F.

In the illustrated example, it is determined that there is any identification information associated with the fifth charger 400E. The determiner 600b determines that the fifth charger 400E is currently in use or the fifth charger 400E is expected to be used in the near future. It is also determined that there is any identification information associated the sixth charger 400F. The determiner 600b determines that the sixth charger 400F is currently in use or the sixth charger 400F is expected to be used in the near future.

Then, the determiner 600b acquires the type information of the battery, the SOC information of the battery, and the version information, which are included in the vehicle-related information of the vehicle 900 corresponding to the identification information associated with the fifth charger 400E currently in use. The determiner 600b predicts, based on the acquired information, a charging end timing at which the charging of the battery using the fifth charger 400E ends. The determiner 600b also acquires the type information of the battery, the SOC information of the battery, and the version information, which are included in the vehicle-related information of the vehicle 900 corresponding to the identification information associated with the sixth charger 400F currently in use. The determiner 600b predicts, based on the acquired information, a charging end timing at which the charging of the battery using the sixth charger 400F ends. Further, the determiner 600b predicts an earlier one of the charging end timing of the fifth charger 400E and the charging end timing of the sixth charger 400F.

The determiner 600b sets a chargeable timing so that the battery mounted on the next vehicle 900 in the queue waiting to charge can be charged after the predicted earlier charging end timing. The chargeable timing includes an expected charging start time at which charging is expected to start, an expected charging end time at which charging is expected to end, and information indicating the position of the vehicle 900 in the queue waiting to charge. For example, the chargeable timing includes information such as the time period from an expected charging start time of xx:xx am (or pm) to an expected charging end time of yy:yy am (or pm) and the second vehicle in the queue waiting to charge.

The expected charging start time is, for example, a time that is a predetermined time after the predicted charging end timing. The predetermined time is a time taken for the vehicle 900 that has completed charging to leave the space in front of the charger 400. However, the predetermined time is not limited thereto, and may be 0, for example. The expected charging end time is a time at which the charging of the battery of the vehicle 900 using the charger 400 ends. The expected charging end time is derived based on the expected charging start time, the type information of the battery, the SOC information of the battery, and the version information. In one example, the determiner 600b derives the charging time of the battery mounted on the vehicle 900, based on the SOC information. At this time, the determiner 600b may derive the charging time in consideration of the battery type information supported by the charger 400 and the type information of the battery mounted on the vehicle 900. Additionally or alternatively, the determiner 600b may derive the charging time in consideration of version information of software of the charger 400 used for battery charging and the version information of the software used to charge the battery of the vehicle 900. The embodiment of the disclosure describes an example in which the determiner 600b determines the expected charging end time, based on both the type information of the battery of the vehicle 900 and the version information of the vehicle 900. However, the disclosure is not limited thereto, and the determiner 600b may determine the expected charging end time, based on any one of the type information of the battery of the vehicle 900 and the version information of the vehicle 900. For example, the determiner 600b may determine the expected charging end time, based on only the type information of the battery of the vehicle 900. Alternatively, the determiner 600b may determine the expected charging end time, based on only the version information of the vehicle 900. The same applies to the following description. The order of one or more vehicles 900 in the queue waiting to charge is derived based on the number of pieces of identification information associated with any one of the chargers 400.

In the illustrated example, it is assumed that the expected charging end time of the fifth charger 400E is earlier than the expected charging end time of the sixth charger 400F. The determiner 600b performs an association process to associate the identification information of the vehicle 900 with the chargeable timing set for the fifth charger 400E. The identification information of the vehicle 900 and the chargeable timing set for the charger 400, which are associated with each other by the association process, are stored in the data holder 620 of the first control device 600.

As described above, when associating one charger 400 with multiple pieces of identification information, the determiner 600b sets different chargeable timings for the respective vehicles 900 corresponding to the multiple pieces of identification information. When the determiner 600b performs the process of associating the charger 400 with each of the pieces of identification information of the vehicles 900, the generator 600c generates a password corresponding to the identification information. The generated password is also stored in the data holder 620 of the first control device 600 in association with the identification information of the vehicle 900 and information on the charger 400.

The notifier 600d transmits the generated password to the second communicator 800a of the second control device 800 via the first communicator 600a of the first control device 600. The notifier 800b of the second control device 800 notifies the driver of the vehicle 900 of the password received from the second communicator 800a. Accordingly, the driver of the vehicle 900 is notified of the generated password.

Further, the notifier 600d transmits the information on the charger 400 and the information on the chargeable timing, which are associated with the identification information of the vehicle 900, to the second communicator 800a of the second control device 800 via the first communicator 600a of the first control device 600. The notifier 800b of the second control device 800 notifies the driver of the vehicle 900 of the information on the charger 400 and the information on the chargeable timing, which are received from the second communicator 800a. In the illustrated example, the driver of the vehicle 900 is notified of the information on the fifth charger 400E associated with the identification information and the information indicating the time period from the expected charging start time of xx:xx am (or pm) to the expected charging end time of yy:yy am (or pm) and the second vehicle in the queue waiting to charge.

As illustrated in FIG. 6, the vehicle 900 that has been notified of the information on the charger 400 and the information on the chargeable timing is guided to wait in a vehicle queuing space until the expected charging start time of xx:xx am (or pm) is reached. The vehicle 900 may be guided by the notifier 800b of the second control device 800 of the vehicle 900 or by the display device 700 in the charging station S.

When the fifth charger 400E ends the charging process and the expected charging start time of xx:xx am (or pm) is reached, a message indicating that the fifth charger 400E is available for use is transmitted from the notifier 600d to the vehicle 900 corresponding to the identification information associated with the fifth charger 400E. The notifier 800b of the second control device 800 receives the message and notifies the driver of the vehicle 900 of the message. Accordingly, the driver can drive the vehicle 900 to move from the vehicle queuing space to the fifth charger 400E.

If the message indicating that the fifth charger 400E is available for use is not receivable by the second control device 800, the vehicle number information analyzed based on the image data of the image captured by the imaging device 500 is displayed on the display device 700 in addition to the message. Accordingly, the driver of the vehicle 900 corresponding to the vehicle number information can be notified of the message described above, and the driver can drive the vehicle 900 to move the vehicle 900 from the vehicle queuing space to the fifth charger 400E.

When the vehicle 900 arrives in front of the fifth charger 400E, the first control device 600 communicates with the second control device 800 of the vehicle 900 located in front of the fifth charger 400E, and re-acquires the vehicle-related information of the vehicle 900 from the second control device 800.

The permitter 600e refers to the data holder 620 and checks whether the charger 400 associated with the identification information included in the re-acquired vehicle-related information matches the fifth charger 400E. Further, the driver of the vehicle 900 inputs the notified password to an input unit (not illustrated) of the fifth charger 400E. The permitter 600e refers to the data holder 620 and checks whether the input password matches a password associated with the re-acquired identification information.

Further, the permitter 600e refers to the data holder 620 and checks whether the current time matches the chargeable timing associated with the re-acquired identification information. In other words, the permitter 600e checks whether the identification information of the vehicle 900 located in front of one of the chargers 400 matches identification information associated with the charger 400 and the current time matches the chargeable timing associated with the identification information.

When a match is found, the permitter 600e permits, only at the set chargeable timing, the charger 400 associated with the identification information of the vehicle 900 to be used to charge the battery of the vehicle 900 corresponding to the identification information. This allows the vehicle 900 entering the charging station S to use only the charger 400 associated with the identification information of the vehicle 900. Accordingly, even if another vehicle cuts in front of the vehicle 900 and comes to a stop in front of the fifth charger 400E, the other vehicle is not allowed to use the fifth charger 400E since the identification information of the other vehicle is not associated with the fifth charger 400E. Thus, the other vehicle can be prevented from cutting in line to charge first. As a result, it is possible to prevent unexpected waiting for charging in the charging station S.

Further, the determiner 600b determines the charger 400 associated with the identification information of the vehicle 900, based on the information related to the battery of the vehicle 900. For example, the determiner 600b determines the charger 400 associated with the identification information of the vehicle 900, based on the type information of the battery of the vehicle 900. This allows the vehicle 900 to be charged using the charger 400 supporting the type information of the battery mounted on the vehicle 900. Accordingly, the battery can be charged efficiently.

Additionally or alternatively, the determiner 600b determines the charger 400 associated with the identification information of the vehicle 900, based on the information related to the software used in the vehicle 900 for charging. This allows the vehicle 900 to be charged using the charger 400 supporting the version information of the software used for charging. Accordingly, the battery can be charged efficiently.

Further, the notifier 600d can notify the vehicle 900 of the chargeable timing. This allows the driver of the vehicle 900 to grasp an approximate time at which the battery can be charged.

Further, the determiner 600b sets the chargeable timing, based on the information related to the battery of the vehicle 900. Additionally or alternatively, the determiner 600b sets the chargeable timing, based on the information related to the software used in the vehicle 900 for charging. This allows accurate derivation of the charging time for charging the battery of the vehicle 900 and accurate derivation of the expected charging end time.

The permitter 600e permits charging only when the driver inputs the password. This makes it possible to more reliably prevent a cutting-in-line behavior that occurs when another vehicle enters between a target vehicle and an associated charger 400 and cuts in front of the target vehicle to charge first. For example, even if another vehicle cuts in front of a target vehicle whose identification information can be checked against identification information associated with any one of the chargers 400, the other vehicle is not allowed to be charged unless the driver of the other vehicle can input a correct password. This makes it possible to more reliably prevent the cutting-in-line behavior.

When the vehicle 900 leaves the charging station S from the exit gate 300 after the charging is completed, the first control device 600 communicates with the second control device 800 of the vehicle 900 located in front of the exit gate 300, and re-acquires the vehicle-related information including the identification information of the vehicle 900 from the second control device 800.

The permitter 600e performs a process of deleting the re-acquired identification information and the information on the charger 400 associated with the identification information from the data holder 620. When the process of deleting such information from the data holder 620 is performed, the exit gate 300 is controlled to change from the closed position to the open position to allow the vehicle 900 to leave the charging station S. At this time, the permitter 600e performs a process of setting and changing a chargeable timing in response to the vehicle 900 leaving the charging station S.

For example, when the vehicle 900 that has been charged using the fifth charger 400E leaves the charging station S, the identification information associated with the fifth charger 400E is deleted from the data holder 620. In this case, for example, a process of incrementing the position of a vehicle 900 in a queue waiting for the fifth charger 400E, which is stored in the data holder 620, is performed. When the process of incrementing the position in the queue is performed, the notifier 600d transmits information on the incremented position to the second communicator 800a of the second control device 800 of the vehicle 900 in the queue via the first communicator 600a. Accordingly, the driver of the vehicle 900 waiting in the vehicle queuing space can recognize the position of the vehicle 900 in the queue until the corresponding charger 400 becomes available for use.

As described above, the permitter 600e sets a chargeable timing in response to the vehicle 900 leaving the charging station S. Accordingly, at the timing when the vehicle 900 that has been charged using any one of the chargers 400 leaves the charging station S, the order of one or more vehicles in a queue waiting for the charger 400 can be reflected in real time.

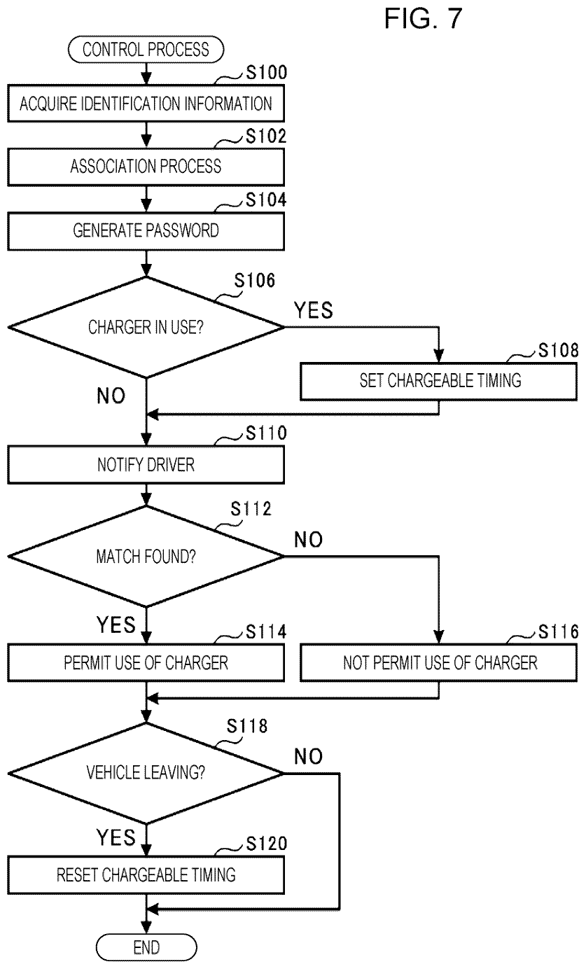

FIG. 7 is a flowchart of a control process performed in the control system 100 according to the embodiment of the disclosure. As illustrated in FIG. 7, first, the first communicator 600a communicates with the second control device 800 mounted on the vehicle 900 that comes to a stop at the entrance gate 200 to enter the charging station S, and acquires vehicle-related information including identification information for identifying the vehicle 900 that is to enter the charging station S (step S100).

The determiner 600b executes an association process to associate the acquired identification information with any one of the chargers 400 in the charging station S (step S102). Further, the generator 600c generates a password corresponding to the acquired identification information (step S104).

The determiner 600b determines whether the charger 400 associated with the identification information is currently in use (step S106). If the charger 400 is currently in use (YES in step S106), the determiner 600b sets a chargeable timing in association with the identification information (step S108).

On the other hand, if the charger 400 is not currently in use (NO in step S106), the notifier 600d transmits the information on the charger 400 associated with the identification information and the password to the second control device 800 and notifies the driver of the vehicle 900 of the information and the password (step S110). When the chargeable timing is set in step S108, the notifier 600d transmits the information on the charger 400 associated with the identification information, the password, and the information on the chargeable timing to the second control device 800 and notifies the driver of the vehicle 900 of the information and the password. When the expected charging start time is reached, the notifier 600d notifies the driver of the waiting vehicle 900 of a message to guide the driver to an available charger 400.

When the vehicle 900 arrives in front of the charger 400, the first communicator 600a of the first control device 600 communicates with the second control device 800 of the vehicle 900 located in front of the charger 400, and re-acquires the identification information of the vehicle 900 from the second control device 800. Then, the permitter 600e refers to the data holder 620 and checks whether the re-acquired identification information matches identification information associated with the charger 400 (step S112). Further, the driver of the vehicle 900 inputs the notified password to an input unit (not illustrated) of the charger 400. The permitter 600e refers to the data holder 620 and checks whether the input password matches a password associated with the re-acquired identification information. Further, the permitter 600e refers to the data holder 620 and checks whether the current time matches the chargeable timing associated with the re-acquired identification information.

If a match is found (YES in step S112), the permitter 600e permits, only at the set chargeable timing, the charger 400 associated with the identification information of the vehicle 900 to be used to charge the battery of the vehicle 900 corresponding to the identification information (step S114). On the other hand, if no match is found (NO in step S112), the permitter 600e does not permit the charger 400 to be used to charge the battery of the vehicle 900 (step S116).

The permitter 600e determines whether there is a vehicle 900 leaving the exit gate 300 (step S118). For example, if identification information of a vehicle 900 at the exit gate 300 is re-acquired, the permitter 600e determines that there is a vehicle 900 leaving the exit gate 300. On the other hand, if identification information of a vehicle 900 at the exit gate 300 is not re-acquired, the permitter 600e determines that there is no vehicle 900 leaving the exit gate 300.

If it is determined that there is a vehicle 900 leaving the exit gate 300 (YES in step S118), the permitter 600e deletes the identification information of the leaving vehicle 900, and changes and resets a chargeable timing (step S120).

While a preferred embodiment of the disclosure has been described above with reference to the accompanying drawings, it is to be understood that the disclosure is not limited to such an embodiment. It will be apparent to those skilled in the art that various modifications and variations may be made without departing from the spirit or scope of the disclosure as defined in the appended claims.

A series of processes performed by devices, namely, the first control device 600 and the second control device 800 according to the embodiment of the disclosure described above, may be implemented using any of software, hardware, or a combination of software and hardware. A program implementing the software is stored in advance in, for example, a non-transitory storage medium (or non-transitory media) provided inside or outside the devices. For example, the program is read from a non-transitory storage medium (e.g., a ROM) to a transitory storage medium (e.g., a RAM) and executed by a processor such as a CPU.

It is possible to create a program for implementing each function of each of the devices described above and install the program in a computer of each of the devices described above. The processor executes the program stored in the memory, thereby executing the processing of each of the functions described above. At this time, the program may be shared and executed by multiple processors, or the program may be executed by a single processor. Each function of each of the devices described above may be implemented by cloud computing using multiple computers coupled to each other via a communication network.

The program may be provided and installed in the computer of each device by being distributed from an external device via a communication network. Alternatively, the program may be stored in a non-transitory computer-readable storage medium (or non-transitory computer readable medium) and provided and installed in the computer of each device via the storage medium.

According to the embodiment of the disclosure, it is possible to provide a program for executing the processing of each function of each of the devices described above. It is also possible to provide a non-transitory computer-readable storage medium in which the program is stored. The non-transitory storage medium may be, for example, a disk storage medium such as an optical disk, a magnetic disk, or a magneto-optical disk, or may be a semiconductor memory such as a flash memory or a Universal Serial Bus (USB) memory.

According to an embodiment of the disclosure, it is possible to prevent unexpected waiting for charging.

The first control device 600 illustrated in FIG. 3 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the first control device 600 including the first communicator 600a, the determiner 600b, the generator 600c, the notifier 600d, and the permitter 600e. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 3.

1. A control device comprising:
one or more processors; and
one or more memories coupled to the one or more processors,
the one or more processors being configured to execute processing comprising:
acquiring identification information for identifying a vehicle that is to enter a charging station;
associating the identification information with a charger among chargers located in the charging station; and
permitting a battery of the vehicle identified by the identification information to be charged using the charger with which the identification information is associated.

2. The control device according to claim 1, wherein
the one or more processors are configured to execute processing comprising determining the charger associated with the identification information, based on information related to the battery.

3. The control device according to claim 1, wherein
the one or more processors are configured to execute processing comprising determining the charger associated with the identification information, based on information related to software used in the vehicle for charging of the battery.

4. The control device according to claim 1, wherein
the one or more processors are configured to execute processing comprising, when associating the charger with pieces of the identification information:
setting different chargeable timings for vehicles identified by the pieces of the identification information; and
permitting batteries of the vehicles to be charged using the charger at the set chargeable timings.

5. The control device according to claim 4, wherein
the one or more processors are configured to execute processing comprising providing a notification of the chargeable timings.

6. The control device according to claim 4, wherein
the one or more processors are configured to execute processing comprising setting the chargeable timings based on the vehicles leaving the charging station.

7. The control device according to claim 4, wherein
the one or more processors are configured to execute processing comprising setting the chargeable timings, based on information related to the batteries of the vehicles.

8. The control device according to claim 4, wherein
the one or more processors are configured to execute processing comprising setting the chargeable timings, based on information related to software used in the vehicles for the charging of the batteries.

9. The control device according to claim 1, wherein
the one or more processors are configured to execute processing comprising:
generating a password corresponding to the identification information;
notifying a driver who drives the vehicle identified by the identification information of the password; and
permitting the battery to be charged when the driver inputs the password.

10. The control device according to claim 2, wherein
the one or more processors are configured to execute processing comprising:
generating a password corresponding to the identification information;
notifying a driver who drives the vehicle identified by the identification information of the password; and
permitting the battery to be charged when the driver inputs the password.

11. The control device according to claim 3, wherein
the one or more processors are configured to execute processing comprising:
generating a password corresponding to the identification information;
notifying a driver who drives the vehicle identified by the identification information of the password; and
permitting the battery to be charged when the driver inputs the password.

12. The control device according to claim 4, wherein
the one or more processors are configured to execute processing comprising:
generating a password corresponding to the identification information;
notifying a driver who drives the vehicle identified by the identification information of the password; and
permitting the battery to be charged when the driver inputs the password.

13. The control device according to claim 5, wherein
the one or more processors are configured to execute processing comprising:
generating a password corresponding to the identification information;
notifying a driver who drives the vehicle identified by the identification information of the password; and
permitting the battery to be charged when the driver inputs the password.

14. The control device according to claim 6, wherein
the one or more processors are configured to execute processing comprising:
generating a password corresponding to the identification information;
notifying a driver who drives the vehicle identified by the identification information of the password; and
permitting the battery to be charged when the driver inputs the password.

15. The control device according to claim 7, wherein
the one or more processors are configured to execute processing comprising:
generating a password corresponding to the identification information;
notifying a driver who drives the vehicle identified by the identification information of the password; and
permitting the battery to be charged when the driver inputs the password.

16. The control device according to claim 8, wherein
the one or more processors are configured to execute processing comprising:
generating a password corresponding to the identification information;
notifying a driver who drives the vehicle identified by the identification information of the password; and
permitting the battery to be charged when the driver inputs the password.
